(19) United States
(12) Patent Application Publication
(10) Pub. No.: US 2014/0135067 A1
(43) Pub. Date: May 15, 2014

(54) WIRELESS BASE STATION DEVICE AND COMMUNICATION SYSTEM INCLUDING THE WIRELESS BASE STATION DEVICE

(71) Applicant: NVIDIA CORPORATION, Santa Clara, CA (US)

(72) Inventor: Jiajia Liu, Shenzhen (CN)

(73) Assignee: NVIDIA CORPORATION, Santa Clara, CA (US)

(21) Appl. No.: 13/753,425

(22) Filed: Jan. 29, 2013

(30) Foreign Application Priority Data
Nov. 9, 2012 (CN) 201210448081.2

(51) Int. Cl. H04W 88/08

(52) U.S. Cl. CPC H04W 88/08
USPC 455/561

(57) ABSTRACT

A wireless base station device and a communication system including the wireless base station device are provided in the present invention, The wireless base station device comprises a baseband processing unit, wherein the baseband processing unit comprises a PCIE switch and a graphics processing unit for baseband processing which comprises a PCIE interface to interconnect with the PCIE switch. The wireless base station device and the communication system including the wireless base station device provided by the present invention have lower costs, better performances and shorter time-to-markets, and are easy to be upgraded.

### CROSS-REFERENCE TO RELATED APPLICATIONS

This application claims priority to Chinese Patent Application No. 201210448081.2, filed on Nov. 9, 2012, which is hereby incorporated by reference in its entirety.

### FIELD OF INVENTION

The present invention relates generally to a field of communication infrastructures and, in particular, to a wireless base station device and a communication system including the wireless base station device.

### BACKGROUND

With the development of wireless technologies, such as 3G, HSPA+, WiMAX and LTE, telecommunication equipment manufacturers and network operators are always searching for better solutions for communication infrastructure equipment with a lower cost, a better performance and a shorter time-to-market.

A wireless base station device is an important element in a communication infrastructure.

And a baseband processing unit is one of the most critical sub-systems in a wireless base station device, A baseband processing unit takes digitized baseband radio signals and base station control signals as inputs, and it can communicate with others with multiple synchronized user data channels, wherein there are voices, data and multimedia streams.

In a baseband processing unit of a wireless base station device, many advanced signal processing techniques are used, such as FIR filter, FFT/IFFT, turbo convolution coding/decoding and so on. These signal processing techniques are compute-intensive techniques, which need lots of parallel computations. Because of the requirements for the intensive computation, the cost for implementing a baseband processing unit is very high. Furthermore, the requirements for bandwidth between a baseband processing unit and other units of a wireless base station device are growing, while the prior solutions are difficult to meet the growing bandwidth requirements.

Therefore, a wireless base station device which has a lower cost and can meet bandwidth requirements is needed to be provided to solve the above problems.

### SUMMARY OF THE INVENTION

The present invention is related to a wireless base station device and a communication system including the wireless base station device.

In one aspect of the invention, a wireless base station device is provided. The wireless base station device comprises a baseband processing unit, wherein the baseband processing unit comprises a PCIE switch and a graphics processing unit for baseband processing which comprises a PCIE interface to interconnect with the PCIE switch.

Preferably, the PCIE interface is a PCIE interface with 16 channels.

In a preferred embodiment of the present invention, the wireless base station device further comprises a radio frequency and analog unit and a processor unit, wherein the graphics processing unit communicates with the radio frequency and analog unit and the processor unit through the PCIE switch.

In a preferred embodiment of the present invention, the radio frequency and analog unit comprises a PCIE interface to interconnect with the PCIE switch.

In a preferred embodiment of the present invention, the processor unit comprises a center processing unit.

In a preferred embodiment of the present invention, the center processing unit comprises a gigabit Ethernet interface to interconnect with an external radio network controller,

In a preferred embodiment of the present invention, the processor unit comprises an ARM processor.

In a preferred embodiment of the present invention, the ARM processor comprises a gigabit

Ethernet interface to interconnect with an external radio network controller.

In a preferred embodiment of the present invention, the ARM processor comprises a reduced gigabit media independent interface to interconnect with an external radio network controller through an Ethernet physical layer switch.

In a preferred embodiment of the present invention, the Ethernet physical layer switch interconnects with the external radio network controller through a network card interface.

In another aspect of the invention, a communication system including the wireless base station device is provided. The communication system comprises a wireless base station device, wherein the wireless base station device comprises a baseband processing unit, and the baseband processing unit comprises a PCIE switch and a graphics processing unit for baseband processing which comprises a PCIE interface to interconnect with the PCIE switch.

Preferably, the PCIE interface is a PCIE interface with 16 channels.

In a preferred embodiment of the present invention, the wireless base station device further comprises a radio frequency and analog unit and a processor unit, wherein the graphics processing unit communicates with the radio frequency and analog unit and the processor unit through the PCIE switch.

In a preferred embodiment of the present invention, the radio frequency and analog unit comprises a PCIE interface to interconnect with the PCIE switch.

In a preferred embodiment of the present invention, the processor unit comprises a center processing unit.

In a preferred embodiment of the present invention, the center processing unit comprises a gigabit Ethernet interface to interconnect with an external radio network controller.

In a preferred embodiment of the present invention, the processor unit comprises an ARM processor.

In a preferred embodiment of the present invention, the ARM processor comprises a gigabit Ethernet interface to interconnect with an external radio network controller.

In a preferred embodiment of the present invention, the ARM processor comprises a reduced gigabit media independent interface to interconnect with an external radio network controller through an Ethernet physical layer switch.

In a preferred embodiment of the present invention, the Ethernet physical layer switch interconnects with the external radio network controller through a network card interface.

The above wireless base station device and the communication system including the wireless base station device provided by the present invention have lower costs, better performances and shorter time-to-markets, and are easy to be upgraded.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a structure diagram of a wireless base station device according to a preferred embodiment of the present invention; and

FIG. 2 illustrates a structure diagram of a wireless base station device according to another preferred embodiment of the present invention.

### DETAILED DESCRIPTION

Example embodiments are described herein in the context of wireless base station devices and communication systems including the wireless base station devices. Those of ordinary skill in the art will realize that the following description is illustrative only and is not intended to be in any way limiting. Other embodiments will readily suggest themselves to those skilled in the art having the benefit of this disclosure. Reference will now be made in detail to implementations of the example embodiments as illustrated in the accompanying drawings. The same reference numbers will be used to the extent possible throughout the drawings and the following description to refer to the same or like items.

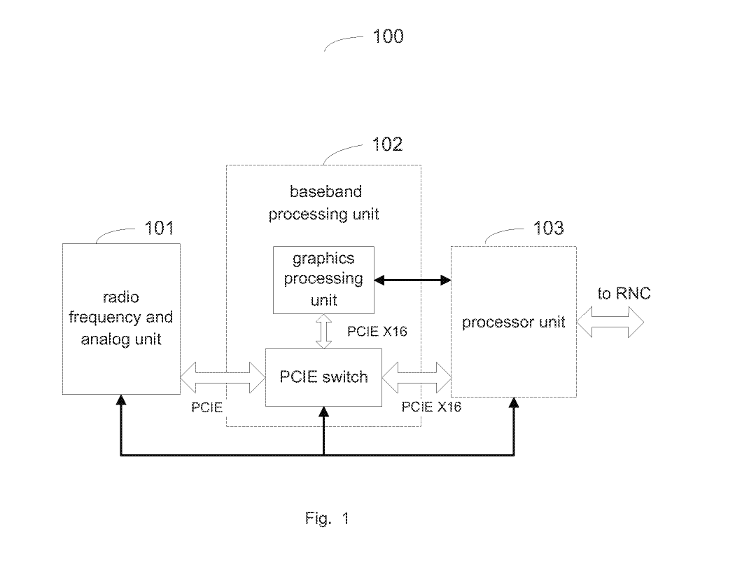

According to one aspect of the present invention, a wireless base station device is provided. FIG. 1 illustrates a structure diagram of a wireless base station device 100 according to a preferred embodiment of the present invention. As shown in FIG. 1, the wireless base station device 100 comprises a baseband processing unit 102, which comprises a PCI-Express (PCIE) switch and a graphics processing unit (GPU) for baseband processing. Wherein, the graphics processing unit comprises a PCIE interface to interconnect with the PCIE switch.

The baseband processing performed by the baseband processing unit 102 comprises many advanced signal processing techniques, such as FIR filter, FFT/IFFT, turbo convolution coding/encoding, modulation/demodulation, spread spectrum/de-spread spectrum, channel estimation and so on. These signal processing techniques are all compute-intensive techniques, which need lots of parallel computations. A GPU is produced in the background that graphics processing becomes more and more important in a modern computer so that a special graphics core processor is needed. Thus a GPU is often used for reducing the dependence of a graphics card on a CPU and performing some operations which are used to be performed by the CPU. However, a GPU has an excellent ability of parallel computing. A GPU can provide ten times and even hundreds of times processing ability than a CPU in computing aspects, such as floating point operation and parallel computing. A GPU can provide a computing power that needs a group of DSPs or FPGAs to provide. For example, the latest TI communication infrastructure SOC TMS320TCI6618 can provide a floating point operation capability of 4×19.2=76.8 GFlops, but it still needs to use a group of DSPs to perform all baseband processing in a base station device, which will increase the cost of the whole system. While only one GPU can provide such a calculation capability. In addition, for requirements for different computation intensity, different GPUs can be used. Therefore, performing baseband processing by using a GPU can reduce the cost of a whole wireless base station device. Furthermore, with the development of wireless technologies, it is frequently necessary to implement a new software core or update a software core. The Compute Unified Device Architecture (CUDA) of a GPU is based on a C/C++ language instead of an assembly language which is the basis of a DSP and a FPGA. So it is much easier to develop a software core of wireless protocol and shorten a time-to-market and a upgrading time of a base station device.

The GPU comprises a PCIE interface to interconnect with the PCIE switch. Preferably, the PCIE interface is a PCIE interface with 16 channels (X16), such as a PCIE 2.0 X16, PCIE is a bus and interface standard popular in the present. PCIE interfaces vary according to the bit widths of buses, including PCIE X1, PCIE X4, PCIE X8 and PCIE X16, wherein PCIE X2 is used for an inner interface instead of a slot mode. A PCIE X1 can provide a transmission rate of 250 MB/s, and a PCIE X16 for a graphics card reaches 4 GB/s. Since a PCIE bus can transmit data simultaneously in an uplink and a downlink, the bandwidth of a PCIE X16 generally is 8 GB/s. Therefore, a PCIE switch can provide a PCIE channel for a GPU and other units of a wireless base station device, and a PCIE channel can provide enough bandwidth for a wireless base station device.

In a preferred embodiment of the present invention, the wireless base station device 100 may also comprise a radio frequency and analog (RF & Analog) unit 101 and a processor unit 103, wherein the GPU communicates with the radio frequency and analog unit 101 and the processor unit 103 through the PCIE switch. The PCIE switch can provide PCIE channels for the communication between the GPU and the radio frequency and analog unit 101 and the communication between the GPU and the processor unit 103 and can provide enough bandwidth for the radio frequency and analog unit 101, the GPU and the processor unit 103.

In a preferred embodiment of the present invention, the radio frequency and analog unit 101 may comprise a PCIE interface to interconnect with the PCIE switch. Optionally, the radio frequency and analog unit 101 may also comprise other interfaces that can interconnect with the PCIE switch. The radio frequency and analog unit 101 provides the wireless base station device 100 with physical layer wireless link transmission of an air interface, related tests and alarm function. The radio frequency and analog unit 101 includes a transmitting channel and a receiving channel. In the receiving channel, a radio frequency signal is amplified, filtered and down converted to be a baseband signal for being processed by the baseband processing unit 102. While in the transmitting channel, a baseband analog signal is modulated, amplified and up converted to be a radio frequency signal to be radiated to the sky by an antenna.

The processor unit 103 provides the baseband processing unit 102 with network interface control processing to make the baseband processing unit 102 to connect with an IP network or a gigabit Ethernet, and it also controls each unit of the wireless base station device 100, such as by providing a clock signal, a power signal and so on.

In a preferred embodiment of the present invention, the processor unit 103 may comprise a center processing unit (CPU). The core functions of a center processing unit are calculating and controlling. Specially, a CPU has functions of instruction sequence control, operation control, timing control and data processing. Therefore, the CPU can provide the baseband processing unit 102 with network interface control processing well and control each unit of the wireless base station device 100.

In a preferred embodiment of the present invention, the CPU may comprise a gigabit

Ethernet interface (not shown in FIG. 1) to interconnect with an external radio network controller (RNC), and thereby the wireless base station device 100 can be connected with a core network (e.g. a 3G core network).

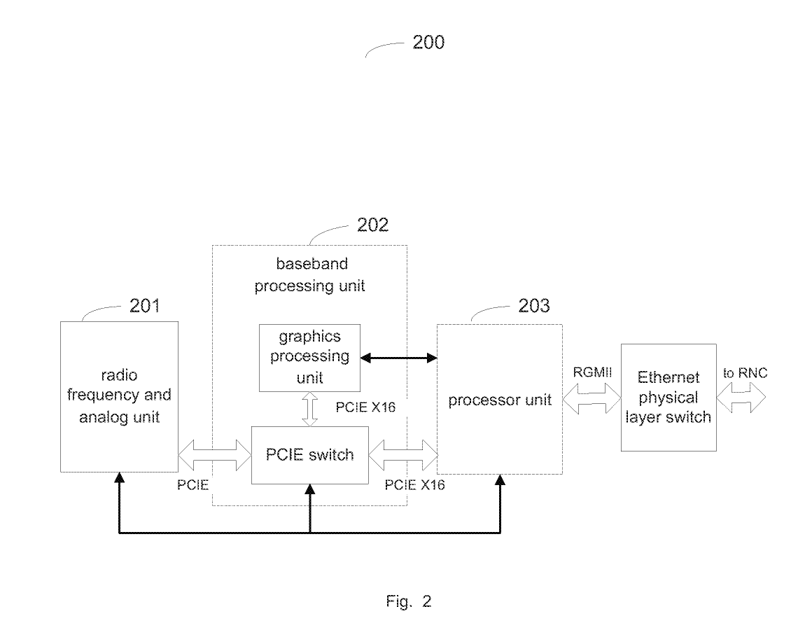

FIG. 2 illustrates a structure diagram of a wireless base station device 200 according to another preferred embodiment of the present invention. For brevity, a detailed description is omitted for the radio frequency and analog unit and the baseband processing unit of the wireless base station device described with reference to the above embodiments, Those skilled in the art can understand that the specific structure and the operation mode thereof with reference to FIG. 1 in combination with the above description.

As shown in FIG. 2, a processor unit 203 may comprise an ARM (Advanced RISC

Machines) processor. An ARM processor has advantages of a small size, low power consumption, a low cost and a high performance. The operation speed of an ARM processor can reach Million Instructions Per Second (MIPS). Preferably, the ARM processor can be a Marvell MV78260 ARM SOC.

In a preferred embodiment of the present invention, the ARM processor may comprise a gigabit Ethernet interface (not shown in FIG. 2) to interconnect with an external radio network controller (RNC). For example, the ARM processor is a high-end ARM processor, which may comprise a gigabit Ethernet interface to connect the wireless base station device 200 with a core network (e.g. a 3G core network) through the external radio network controller.

In a preferred embodiment of the present invention, the ARM processor does not have a physical layer interface, while it may comprise a reduced gigabit media independent interface (RGMII) to interconnect with the external radio network controller through an Ethernet physical layer switch (Ethernet PHI Switch). For example, the ARM processor is a low-end ARM processor, which can comprise a reduced gigabit media independent interface (RGMII) to connect the wireless base station device 200 with a core network (e.g. a 3G core network) through the external radio network controller.

The Ethernet physical layer switch may interconnect with the external radio network controller through a network card interface. Optionally, the network card interface may be a RJ45 connector.

In addition, it should be noted that the above term “interconnect” and “connect” may represent a direct connection or an indirect connection.

According to another aspect of the present invention, a communication system is also provided, which comprises the above-mentioned wireless base station device. For simplicity, brief description is omitted for the wireless base station device which refers to the one described in the above embodiments. Those skilled in the art can understand the detailed structure and operation method of wireless base station device by referring to FIG. 1 and FIG. 2 according to the above description. For brevity, a detailed description is omitted for the wireless base station device described with reference to the above embodiments. Those skilled in the art can understand that the specific structure and the operation mode thereof with reference to FIGS. 1 and 2 in combination with the above description.

The wireless base station device and the communication system including the wireless base station device provided by the present invention have lower costs, better performances and shorter time-to-markets, and are easy to be upgraded.

It should be appreciated that various modifications, adaptations and alternative embodiments thereof may be made within the scope and spirit of the present invention. The invention is further defined by the following claims.

What is claimed is:

1. A wireless base station device comprising:
a baseband processing unit,
wherein the baseband processing unit comprises a PCIE switch and a graphics processing unit for baseband processing which comprises a PCIE interface to interconnect with the PCIE switch.

2. The wireless base station device of claim 1, wherein the PCIE interface is a PCIE interface with 16 channels.

3. The wireless base station device of claim 1, further comprising a radio frequency and analog unit and a processor unit, wherein the graphics processing unit communicates with the radio frequency and analog unit and the processor unit through the PCIE switch.

4. The wireless base station device of claim 3, wherein the radio frequency and analog unit comprises a PCIE interface to interconnect with the PCIE switch.

5. The wireless base station device of claim 3, wherein the processor unit comprises a center processing unit.

6. The wireless base station device of claim 5, wherein the center processing unit comprises a gigabit Ethernet interface to interconnect with an external radio network controller.

7. The wireless base station device of claim 3, wherein the processor unit comprises an ARM processor.

8. The wireless base station device of claim 7, wherein the ARM processor comprises a gigabit Ethernet interface to interconnect with an external radio network controller.

9. The wireless base station device of claim 7, wherein the ARM processor comprises a reduced gigabit media independent interface to interconnect with an external radio network controller through an Ethernet physical layer switch.

10. The wireless base station device of claim 9, wherein the Ethernet physical layer switch interconnects with the external radio network controller through a network card interface.

11. A communication system comprising:
a wireless base station device,
wherein the wireless base station device comprises a baseband processing unit, and the baseband processing unit comprises a PCIE switch and a graphics processing unit for baseband processing which comprises a PCIE interface to interconnect with the PCIE switch.

12. The communication system of claim 11, wherein the PCIE interface is a PCIE interface with 16 channels.

13. The communication system of claim 11, wherein the wireless base station device further comprises a radio frequency and analog unit and a processor unit, wherein the graphics processing unit communicates with the radio frequency and analog unit and the processor unit through the PCIE switch.

14. The communication system of claim 13, wherein the radio frequency and analog unit comprises a PCIE interface to interconnect with the PCIE switch.

15. The communication system of claim 13, wherein the processor unit comprises a center processing unit.

16. The communication system of claim 15, wherein the center processing unit comprises a gigabit Ethernet interface to interconnect with an external radio network controller,

17. The communication system of claim 13, wherein the processor unit comprises an ARM processor.

18. The communication system of claim 17, wherein the ARM processor comprises a gigabit Ethernet interface to interconnect with an external radio network controller.

19. The communication system of claim 17, wherein the ARM processor comprises a reduced gigabit media independent interface to interconnect with an external radio network controller through an Ethernet physical layer switch.

20. The communication system of claim 19, wherein the Ethernet physical layer switch interconnects with the external radio network controller through a network card interface.
